(19) United States
(12) Patent Application Publication
(10) Pub. No.: US 2025/0061484 A1
(43) Pub. Date: Feb. 20, 2025

(54) SYSTEMS AND METHODS FOR MODELS OMISSION

(71) Applicant: YAHOO AD TECH LLC, New York, NY (US)

(72) Inventors: Oron MADMON, New York, NY (US); Alexander ZLOTNIK, New York, NY (US); Rina LEIBOVITS, New York, NY (US)

(21) Appl. No.: 18/452,262

(22) Filed: Aug. 18, 2023

(51) Int. Cl. G06Q 30/0242; G06Q 30/0202

(52) U.S. Cl. CPC G06Q 30/0246; G06Q 30/0202

(57) ABSTRACT

Systems and methods are disclosed for model evaluation and performance-based selection. One method comprises receiving, by one or more processors, a model and corresponding configuration information, creating one or more model variations based on the model and corresponding configuration information, determining a model variation subset based on one or more evaluation scores of each of the one or more model variations, omitting the one or more model variations not included in the model variation subset, initiating one or more new model variations based on the model variation subset, determining a best model of the one or more new model variations based on one or more new model evaluation scores for each of the one or more new model variations, and omitting the one or more new model variations except the best model.

### TECHNICAL FIELD

The present disclosure relates generally to delivering Internet content and advertising and, more particularly, to systems and methods for a models omission technique that saves resources while training prediction models.

### BACKGROUND

In recent years, people have started spending more and more time browsing content on the Internet, as opposed to traditional sources, such as television, radio, and print media. As a result, the value of advertising on web pages has risen significantly, and techniques for targeting demographics of interest have become very advanced. Models are used to accurately identify the user viewing and interacting with an advertisement in order to tailor the advertisement to the user's specific interests, provide frequency capping, and provide other user specific functionality. In the world of behavioral advertising, the user's identity is often tied to a user profile containing information about their demographics, interests, and programmatically determined properties. This allows the advertisement to be highly targeted to the specific user, providing more relevant offers and improving click through and conversion rates.

Models are used to predict if a user will click an advertisement. Models may go through one or more training processes to better predict if a user will click an advertisement or not. Conventional approaches for training the models may include training multiple copies of the models in parallel, while ignoring the resource consumption. Upon training, the best model may be used for production. However, a significant portion of the models cannot become the best model. As a result, resources that are used to train such models are wasted. Additionally, other conventional approaches may include randomly selecting which models to train to avoid high resource consumption. However, such an approach does not take the performance of the model into account, thus resulting in low-quality models.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Embodiments of the present disclosure include systems and methods for model evaluation and performance-based selection.

According to certain embodiments, computer-implemented methods are disclosed for model evaluation and performance-based selection are disclosed. One method may include receiving, by one or more processors, a model and corresponding configuration information. The method may include creating, by the one or more processors, one or more model variations based on the model and corresponding configuration information. The method may include determining, by the one or more processors, a model variation subset based on one or more evaluation scores of each of the one or more model variations. The method may include omitting, by the one or more processors, the one or more model variations not included in the model variation subset. The method may include initiating, by the one or more processors, one or more new model variations based on the model variation subset. The method may include determining, by the one or more processors, a best model of the one or more new model variations based on one or more new model evaluation scores for each of the one or more new model variations. The method may include omitting, by the one or more processors, the one or more new model variations except the best model.

According to certain embodiments, a computer system for model evaluation and performance-based selection is disclosed. The computer system may comprise a memory having processor-readable instructions stored therein, and one or more processors configured to access the memory and execute the processor-readable instructions, which when executed by the one or more processors configures the one or more processors to perform a plurality of functions. The functions may include receiving a model and corresponding configuration information. The functions may include creating one or more model variations based on the model and corresponding configuration information. The functions may include determining a model variation subset based on one or more evaluation scores of each of the one or more model variations. The functions may include omitting the one or more model variations not included in the model variation subset. The functions may include initiating one or more new model variations based on the model variation subset. The functions may include determining a best model of the one or more new model variations based on one or more new model evaluation scores for each of the one or more new model variations. The functions may include omitting the one or more new model variations except the best model.

According to certain embodiments, a non-transitory computer-readable medium containing instructions for model evaluation and performance-based selection is disclosed. The instructions may include receiving a model and corresponding configuration information. The instructions may include creating one or more model variations based on the model and corresponding configuration information. The instructions may include determining a model variation subset based on one or more evaluation scores of each of the one or more model variations. The instructions may include omitting the one or more model variations not included in the model variation subset. The instructions may include initiating one or more new model variations based on the model variation subset. The instructions may include determining a best model of the one or more new model variations based on one or more new model evaluation scores for each of the one or more new model variations. The instructions may include omitting the one or more new model variations except the best model.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a schematic diagram illustrating an example environment implementing methods and systems of this disclosure, according to one or more embodiments.

FIG. 2 depicts a flow diagram of an exemplary method for model evaluation and selection, according to one or more embodiments.

FIG. 3 depicts a schematic diagram of an exemplary method for model evaluation and selection, according to one or more embodiments.

FIG. 4 depicts an example system that may execute techniques presented herein.

### DETAILED DESCRIPTION OF EMBODIMENTS

According to certain aspects of the disclosure, methods and systems are disclosed for using model omission techniques to evaluate and select models. Conventional techniques may not be suitable at least because conventional techniques, among other things, unnecessarily utilize resources when training models for predicting users' interactions with online advertisements. Additionally, conventional techniques may randomly select models to train, disregarding the model's performance. Accordingly, improvements in technology relating to the process of training models for predicting user's interactions with online advertisements are needed.

In recent years, people have started spending more and more time browsing content on the Internet, as opposed to traditional sources, such as television, radio, and print media. As a result, the value of advertising on web pages has risen significantly, and techniques for targeting demographics of interest have become very advanced. Models are used to accurately identify the user viewing an advertisement in order to tailor the advertisement to the user's specific interests, provide frequency capping, and provide other user specific functionality. In the world of behavioral advertising, the user's identity is often tied to a user profile containing information about their demographics, interests, and programmatically determined properties. This allows the advertisement to be highly targeted to the specific user, providing more relevant offers and improving click through and conversion rates.

Models are used to predict if a user will click an advertisement. Models may go through one or more training processes to better predict if a user will click an advertisement or not. Conventional approaches for training the models may include training multiple copies of the models in parallel, while ignoring the resource consumption. Upon training, the best model may be used for production. However, a significant portion of the models cannot become the best model. As a result, resources that are used to train such models are wasted. Additionally, other conventional approaches may include randomly selecting which models to train to avoid high resource consumption. However, such an approach does not take the performance of the model into account, thus resulting in low-quality models. As a result, improvements in evaluating and selecting models to train for advertisement prediction are needed.

This disclosure provides systems and methods for using model omission techniques to reduce resource consumption by using a performance-based selection of models to stop training. The systems and methods may include receiving a model and corresponding configuration information. The systems and methods may include creating one or more model variations based on the model and corresponding configuration information. The systems and methods may include determining a model variation subset based on one or more evaluation scores of each of the one or more model variations. The systems and methods may include omitting the one or more model variations not included in the model variation subset. The systems and methods may include initiating one or more new model variations based on the model variation subset. The systems and methods may include determining a best model of the one or more new model variations based on one or more new model evaluation scores for each of the one or more new model variations. The systems and methods may include omitting the one or more new model variations except the best model.

Advantages of such a system may include reducing resource consumption while maintaining performance during the training of models. For example, the system may analyze the performance of the models to determine which models have a low performance and should be omitted from training. The system may then end the resource consumption for such models. Additional advantages may include a better way of selecting the best model by using performance metrics to determine which models should continue training. Additional advantages may also include increasing efficiency by ending resource consumption earlier in the training process.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of +10% in a stated value. The term “exemplary” is used in the sense of “example” rather than “ideal.” As used herein, the singular forms “a,” “an,” and “the” include plural reference unless the context dictates otherwise.

As used herein, a “machine-learning model,” “model”, or a “deep learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model/system is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosting machine (GBM), decision tree, gradient boosting in a decision tree, deep learning, and/or a deep neural network. Supervised and/or unsupervised training may be employed. For example, supervised learning may include providing training data and classifications corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

### Exemplary Environment

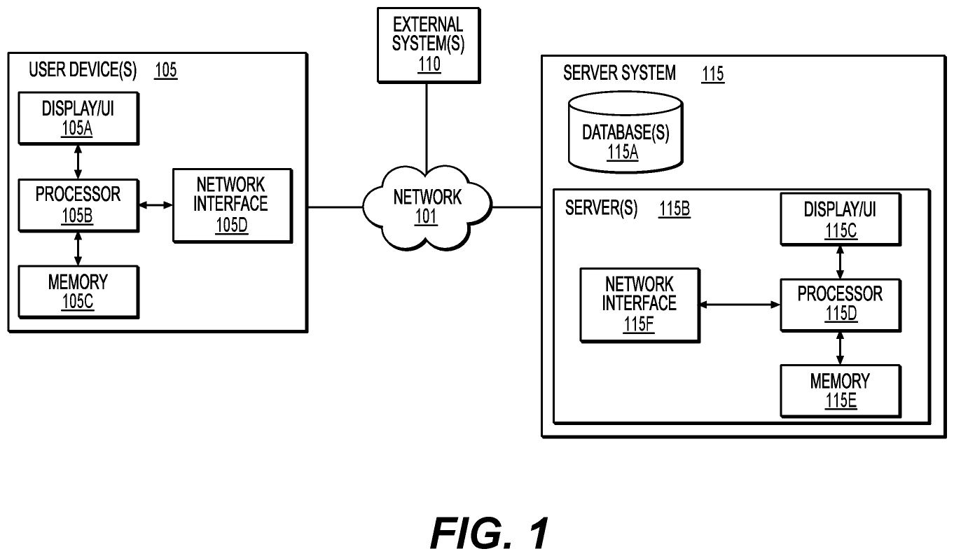

FIG. 1 depicts an exemplary environment 100 that may be utilized with the techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user associated with one or more of generating, training, or tuning a model.

In some embodiments, the components of the environment 100 are associated with a common entity. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a model.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various query analysis tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a model configured to predict user clicks. The server system 115 may include a model and/or instructions associated with the model, e.g., instructions for generating a model, training the model, using the model, etc. The server system 115 may include training data, e.g., user clicks.

In some embodiments, a system or device other than the server system 115 is used to generate and/or train the model. For example, such a system may include instructions for generating the model, the training data and ground truth, and/or instructions for training the model. A resulting trained model may then be provided to the server system 115.

Generally, a model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between the user clicks/user data and advertisements.

In various embodiments, the variables of a model may be interrelated in any suitable arrangement in order to generate the output. For example, in some embodiments, the model may include signal processing architecture that is configured to identify, isolate, and/or extract features, patterns, and/or structure in a text. For example, the model may include one or more convolutional neural network (“CNN”) configured to identify features in the document information data, and may include further architecture, e.g., a connected layer, neural network, etc., configured to identify a user's response to an advertisement.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to identify a user's response to an advertisement are discussed in further detail in the methods below. In these methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various steps may be added, omitted, and/or rearranged in any suitable manner.

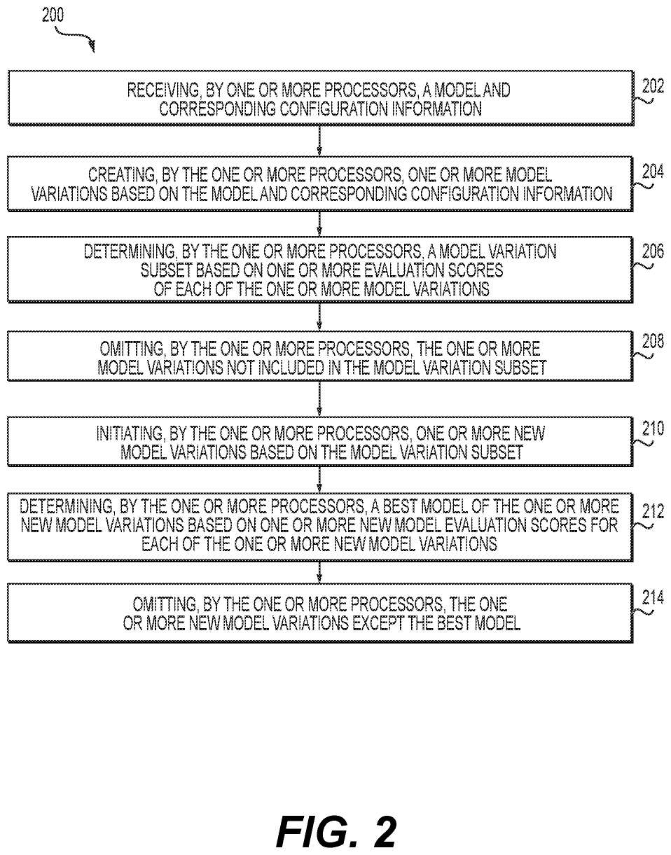

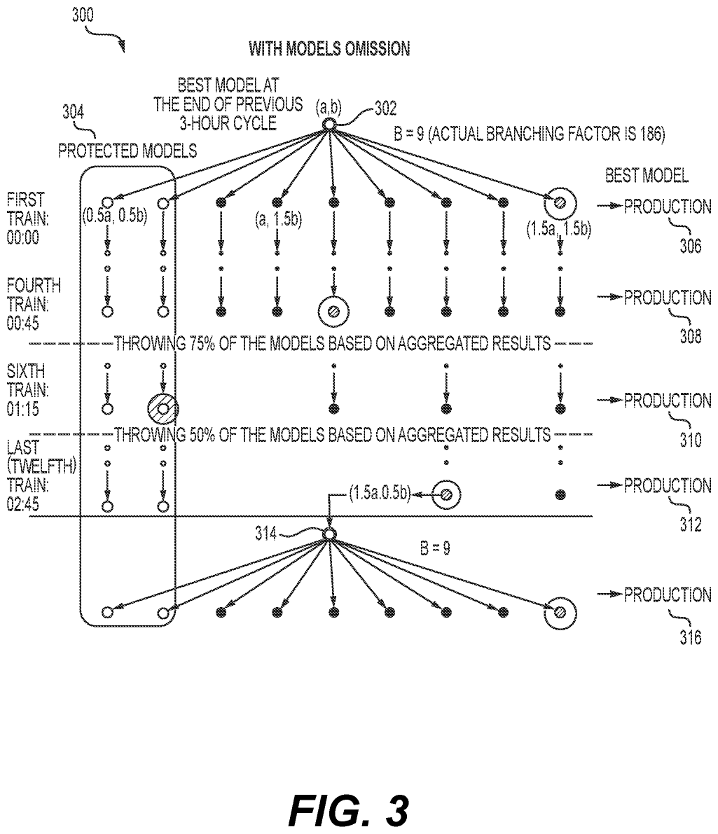

In general, any process or operation discussed in this disclosure that is understood to be computer-implementable, such as the processes illustrated in FIGS. 2-3, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

### Exemplary Method for Model Evaluation and Selection

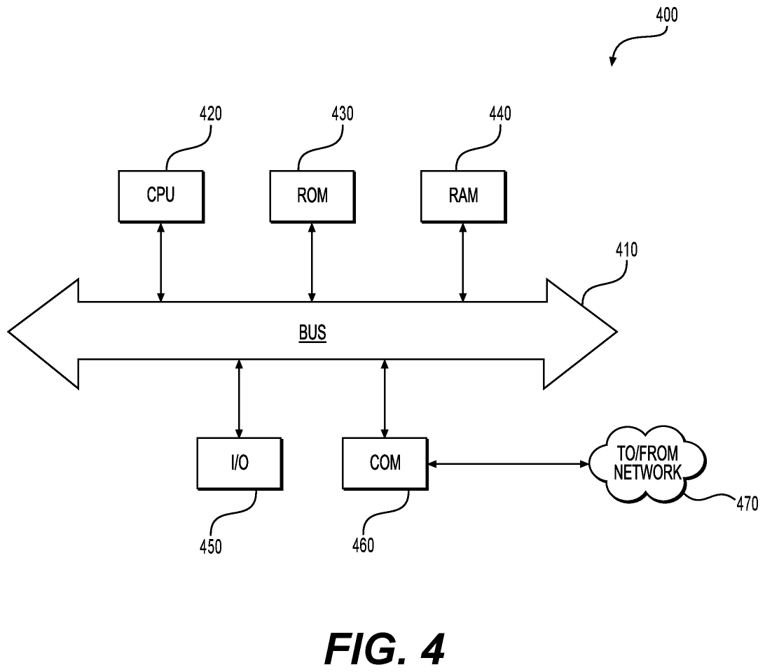

FIG. 2 depicts a flow diagram of an exemplary method 200 for model evaluation and performance-based selection, according to one or more embodiments. Notably, method 200 may be performed by one or more processors of a server that is in communication with one or more user devices and other external system(s) via a network. However, it should be noted that method 200 may be performed by any one or more of the server, one or more user devices, or other external systems. Exemplary method 200 may be executed on one or more components of FIG. 1 or 4.

The method may include receiving, by one or more processors, a model and corresponding configuration information (Step 202). The model may include a model for predicting the click probability of a user on an electronic advertisement. For example, a model may predict the probability for a user to click a specific advertisement. In some embodiments, the model may predict the probability for a user to select a specific advertisement using a technique other than a click. Other models may predict the probability of a user buying a product, the probability of a user signing up for a service on an advertiser's site, and the like. The model may include a set of data representing the prediction of interactions between one or more users and one or more advertisement features. For example, the set of data may contain a vector of numbers for each value of a user feature (e.g., the user's age, the device) and each advertisement feature (e.g., category). The set of data may also contain randomization numbers to allow more or less for specific user or advertisement features in predicting the probability of a user clicking a specific advertisement.

The configuration information may include one or more hyperparameters. The hyperparameters may reflect the changes applied to a model as part of the training process. For example, two models with different hyperparameters will learn user interactions differently. Additionally, the hyperparameters do not need to be constant and may be changed to result in a better model. The hyperparameters may include at least one of: an initial value, a lower exploration initial value, and an upper exploration initial value. The model may utilize one or more resources, such as processor usage, disk usage, and/or networking resources. Additionally, for example, a model may be trained by adjusting the predicted outcome of a user-advertisement interaction to the real outcome. A hyperparameter may denote a parameter that may affect model training. For example, a hyperparameter may be a “step size,” where the step size may mark how much each vector of a participating feature may be increased or decreased in the direction from the predicted event to the real event. The set of values of the one or more hyperparameters may be part of the configuration.

The method may include creating, by the one or more processors, one or more model variations based on the model and corresponding configuration information (Step 204). The model variations may include copies of the model, but the model variations may utilize different configuration information for the training process. For example, the model variations may include one or more hyperparameters that are different from each other. Additionally, the model variations may be created using the same configuration information, but as the model variations are trained, the configuration information may change and become different for each model variation. For example, the configuration information may be updated in time dependent cycles (e.g., the hyperparameters may be updated every 15 minutes). Additionally, creating the model variations may trigger the initialization of the training process for each of the model variations. For example, creating the model variations may include initializing one or more training processes, one or more additional processes, and/or one or more resources.

In some embodiments, the method may include assigning, by the one or more processors, a protected classification to at least one of the one or more model variations, wherein the protected classification indicates that at least one of the one or more model variations is to be included in the model variation subset. The protected classification may indicate that the corresponding model variation should keep training until the final selection of the best model. For example, as will be discussed below, the model variations not included in the model variation subset will be stopped. As a result, the model variations with a protected classification should be included in the model variation subset to continue training. The protected classification may be assigned to the model variations before the training for the model variations begins. In some embodiments, the protected classification may be assigned to the model variations after the training for the model variations has begun. A user may select the one or more model variations that should have a protected classification. Additionally, or alternatively, the system may automatically analyze the model variations and determine the model variations that should have a protected classification. The analyzing may include analyzing the configuration information of the model variations, where assigning the protected classification may depend on the configuration information of the model variation.

The method may include receiving, by the one or more processors, interaction data of each of the one or more model variations. The interaction data may include an estimated click prediction. For example, the interaction data may include an estimated click prediction for a particular online advertisement, where the estimate click prediction corresponds to an amount of times a user may interact (e.g., click) with the online advertisement.

The method may include analyzing, by the one or more processors, the one or more model variations to determine one or more evaluation scores for each of the one or more model variations, wherein the one or more evaluation scores are based on the interaction data. The analyzing the one or more model variations may occur after a threshold time period, wherein the threshold time period corresponds to a set time interval. For example, the model variations may be analyzed in 15 minute intervals. The evaluation scores may be based on one or more aggregated log losses. Additionally, or alternatively, the one or more evaluation scores may be based on one or more user interactions with the one or more model variations. For example, for each event where a user may see an advertisement, there may be a prediction of the probability of an interaction (e.g., a click). Such a prediction may be identified as “p %”. In any case, whether the interaction happens or not, there may be an error. If the model predicted a 90% click, and a click happened, then the error may be 10%. If the click did not happen, the mistake may be 90%. The evaluation score may include a function invoked on each error and aggregation of the mistake values.

Additionally, analyzing the one or more model variations may include determining the one or more model variations with a highest evaluation score. For example, the evaluation scores may be compared against a threshold score, where evaluation scores above a threshold may be determined to have a highest evaluation score. In some embodiments, the highest evaluation score may include more than one highest evaluation score. For example, a threshold number of evaluation scores may be compared against a threshold amount, where the threshold amount may be a number of evaluation scores. For example, the threshold amount may be ten, where the ten highest evaluation scores may be determined to be the highest evaluation score.

The method may include determining, by the one or more processors, a model variation subset based on one or more evaluation scores of each of the one or more model variations (Step 206). The model variation subset may include the model variations with a protected classification. For example, the model variation subset may include at least one of the one or more model variations. Additionally, determining the model variation subset may occur after a threshold period of time. For example, the threshold period of time may be 15 minutes, where a new model variation subset may be determined every 15 minutes. In some embodiments, the model variation subset may include the model variations with the highest evaluation score. In some embodiments, the model variation subset may include one model variation with the highest evaluation score. In some embodiments, the model variation subset may include more than one model variation, where each of the model variations have a high evaluation score. For example, as discussed above, where the threshold amount may be 10, the ten highest evaluation scores may be determined to be the highest evaluation score, and the model variation subset may include the model variations corresponding to the ten highest evaluation scores.

The method may include omitting, by the one or more processors, the one or more model variations not included in the model variation subset (Step 208). In some embodiments, the omitting may include omitting, by the one or more processors, one or more processes corresponding to the one or more model variations not included in the model variation subset. The omitting may include stopping the training process for each of the model variations not included in the model variation subset. Additionally, or alternatively, the omitting may include stopping additional processes corresponding to each of the model variations. Additionally, the omitting may further include omitting, by the one or more processors, one or more resources corresponding to the one or more model variations not included in the model variation subset. Additionally, or alternatively, the omitting may include stopping the resource usage corresponding to each of the model variations. Example resources may include memory resources, networking resources, and the like. After the omitting, the model variation(s) included in the model variation subset may be the only model variation(s) still training.

The method may include initiating, by the one or more processors, one or more new model variations based on the model variation subset (Step 210). The initiating may include creating and executing one or more new model variations based on the one or more model variations included in the model variation subset. For example, if the model variation subset includes one model variation, one or more new model variations may be created based on the one model variation in the model variation subset. In some embodiments, the new model variations may be created based on the configuration information of the model variations included in the model variation subset. Additionally, creating the new model variations may trigger the initialization of the training process for each of the new model variations. For example, creating the new model variations may include initializing one or more training processes, one or more additional processes, and/or one or more resources.

The method may include determining, by the one or more processors, a best model of the one or more new model variations based on one or more new model evaluation scores for each of the one or more new model variations (Step 212). For example, the method may include receiving interaction data of each of the one or more new model variations. The method may include analyzing, by the one or more processors, the one or more new model evaluation scores to determine a new model variation as a best model. In some embodiments, the best model may correspond to the new model variation that has the highest evaluation score. In some embodiments, the best model may correspond to the new model variation that meets a different metric.

The method may include omitting, by the one or more processors, the one or more new model variations except the best model (Step 214). The omitting may include stopping the training process for all of the new model variations except the best model. Additionally, or alternatively, the omitting may include stopping additional processes corresponding to all of the new model variations except the best model. Additionally, the omitting may further include omitting, by the one or more processors, one or more resources corresponding all of the new model variations except the best model. Additionally, or alternatively, the omitting may include stopping the resource usage corresponding to all of the new model variations except the best model. Example resources may include memory resources, networking resources, and the like. After the omitting, the best model may remain, where the best model may be selected and used for production, further training, and the like.

In some embodiments, the method may include receiving interaction data of each of the one or more new model variations. The method may also include analyzing the one or more new model variations to determine one or more evaluation scores for each of the one or more new model variations, wherein the one or more evaluation scores are based on the interaction data. The method may also include updating the model variation subset based on one or more evaluation scores of each of the one or more new model variations. For example, the model variation subset may be updated to include only the new model variations with a highest evaluation score. The method may also include omitting the one or more model variations not included in the model variation subset. For example, the new model variations that do not have a highest evaluation score may have the corresponding training process, additional processes, and/or resources stopped. The method may also include initiating one or more new model variations based on the model variation subset. Additionally, the method may include repeating such steps iteratively. In some embodiments, the process may repeat iteratively after a certain period of time. For example, the process may repeat iteratively every 15 minutes.

Although FIG. 2 shows example blocks of exemplary method 200, in some implementations, the exemplary method 200 may include additional blocks, fewer blocks, different blocks, or differently arranged blocks than those depicted in FIG. 2 Additionally, or alternatively, two or more of the blocks of the exemplary method 200 may be performed in parallel.

### Exemplary Method for Model Evaluation and Selection

FIG. 3 depicts a schematic diagram of an exemplary method 300 for model evaluation and selection, according to one or more embodiments.

The exemplary method may include receiving a model (Step 302). In some embodiments, the model may have been a best model at the end of a previous cycle. The model may include configuration data (e.g., (a, b)). The model may include creating a plurality of models variations based on the model. Additionally, one or more models may be classified as protected models (Step 304). The protected classification may indicate that the corresponding model variation should keep training until the selection of the best model at the end of the cycle. For example, two hyperparameters A and B may have values A=a, B=b. The next generation may be created by giving each hyperparameter one of 3 values (+25%, +0%, −25%), which results in a possible branch factor of 9 (3*3). There may be a different number of hyperparameters resulting in a different branch factor.

The exemplary method may include selecting a best model at the end of the first training cycle (Step 306). After selecting the best model, the method may include continuing to train the plurality of model variations and selecting another best model (Step 308). For example, after a certain number of training cycles (e.g., fourth train), where the training cycles occur for a set period of time (e.g., 15 seconds), the method may include selecting another best model based on based on an evaluation score (e.g., aggregated results) of the model variations. The method may include stopping the training process, other processes, and resources for a threshold amount of models (e.g., 75%) (Step 310). For example, based on the evaluation score (e.g., aggregated results), 75% of the models currently running may be omitted. In some embodiments, the threshold amount of models may exclude the protected models, where the protected models may always keep running until the end of the cycle. Additionally, in some embodiments, the threshold amount of models may exclude the models that were previously selected as best. Additionally, after a certain number of training cycles (e.g., sixth train), the method may include stopping the training process, other processes, and resources for a threshold amount of models (e.g., 50%) (Step 312). For example, based on the evaluation score (e.g., aggregated results), 50% of the models currently running may be omitted. In some embodiments, the threshold amount of models may exclude the protected models, where the protected models may always keep running until the end of the cycle. After a certain number of cycles and/or a certain time period (e.g., 3-hour cycle), the method may include analyzing the currently running models to select a best model (Step 314). The method may include creating new model variations based on the best model (Step 316).

Although FIG. 3 shows example blocks of exemplary method 300, in some implementations, the exemplary method 300 may include additional blocks, fewer blocks, different blocks, or differently arranged blocks than those depicted in FIG. 3 Additionally, or alternatively, two or more of the blocks of the exemplary method 300 may be performed in parallel.

### Exemplary Computer System

FIG. 4 illustrates a high-level functional block diagram of an exemplary computer system 400, in which embodiments of the present disclosure, or portions thereof, may be implemented, e.g., as computer-readable code. For example, each of the exemplary devices and systems described above with respect to FIG. 4 can be implemented in computer system 400 using hardware, software, firmware, tangible computer readable media having instructions stored thereon, or a combination thereof and may be implemented in one or more computer systems or other processing systems. Hardware, software, or any combination of such may embody any of the modules and components in FIG. 4, as described above.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the present disclosure, as described above in the examples of FIGS. 1-3 may be implemented using computer system 400, shown in FIG. 4. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

FIG. 4 provides a functional block diagram illustration of general purpose computer hardware platforms. FIG. 4 illustrates a network or host computer platform 400, as may typically be used to implement a server, such as user device(s) 105, external system(s) 110, and server system 115. It is believed that those skilled in the art are familiar with the structure, programming, and general operation of such computer equipment and, as a result, the drawings should be self-explanatory.

A platform for a server or the like 400, for example, may include a data communication interface for packet data communication 460. The platform may also include a central processing unit (CPU) 420, in the form of one or more processors, for executing program instructions. The platform typically includes an internal communication bus 410, program storage, and data storage for various data files to be processed and/or communicated by the platform such as ROM 430 and RAM 440, although the computer platform 400 often receives programming and data via network communications 470. The hardware elements, operating systems, and programming languages of such equipment are conventional in nature, and it is presumed that those skilled in the art are adequately familiar therewith. The computer platform 400 also may include input and output ports 450 to connect with input and output devices such as keyboards, mice, touchscreens, monitors, displays, etc. Of course, the various computer platform functions may be implemented in a distributed fashion on a number of similar platforms, to distribute the processing load. Alternatively, the computer platforms may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It would also be apparent to one of skill in the relevant art that the present disclosure, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

It is to be understood that both the foregoing general description and the following detailed description are exemplary and explanatory only and are not restrictive of the disclosed embodiments, as claimed.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method for model evaluation and performance-based selection, the method comprising:
receiving, by one or more processors, a model and corresponding configuration information;
creating, by the one or more processors, one or more model variations based on the model and the corresponding configuration information;
determining, by the one or more processors, a model variation subset based on a threshold amount and one or more evaluation scores of each of the one or more model variations;
terminating, by the one or more processors, processes and resources for the one or more model variations not included in the model variation subset;
initiating, by the one or more processors, one or more new model variations based on the model variation subset;
determining, by the one or more processors, a best model of the one or more new model variations based on one or more new model evaluation scores for each of the one or more new model variations; and
omitting, by the one or more processors, the one or more new model variations except the best model.

2. The computer-implemented method of claim 1, the claim further comprising:
determining, by the one or more processors, the one or more new model evaluation scores for each of the one or more new model variations; and
analyzing, by the one or more processors, the one or more new model evaluation scores to determine one of the one or more new model variations as the best model.

3. The computer-implemented method of claim 1, the claim further comprising:
receiving, by the one or more processors, interaction data for each of the one or more model variations; and
analyzing, by the one or more processors, the one or more model variations to determine the one or more evaluation scores for each of the one or more model variations, wherein the one or more evaluation scores are based on the interaction data.

4. The computer-implemented method of claim 3, wherein the analyzing the one or more model variations occurs after a threshold time period, wherein the threshold time period corresponds to a set time interval.

5. The computer-implemented method of claim 3, wherein the interaction data includes an estimated click prediction.

6. The computer-implemented method of claim 1, wherein the configuration information includes one or more hyperparameters.

7. The computer-implemented method of claim 6, wherein the one or more hyperparameters include at least one of: an initial value, a lower exploration initial value, and an upper exploration initial value.

8. The computer-implemented method of claim 1, the method further comprising:
assigning, by the one or more processors, a protected classification to at least one of the one or more model variations, wherein the protected classification indicates that at least one of the one or more model variations is to be included in the model variation subset.

9. The computer-implemented method of claim 1, wherein the omitting further comprises:
omitting, by the one or more processors, one or more processes corresponding to the one or more model variations not included in the model variation subset; and
omitting, by the one or more processors, one or more resources corresponding to the one or more model variations not included in the model variation subset.

10. The computer-implemented method of claim 1, wherein analyzing the one or more model variations includes determining the one or more model variations with a highest evaluation score.

11. The computer-implemented method of claim 1, wherein the determining the model variation subset based on the one or more evaluation scores occurs after a threshold period of time.

12. The computer-implemented method of claim 1, wherein the one or more evaluation scores are based on one or more aggregated log losses.

13. The computer-implemented method of claim 1, wherein the one or more evaluation scores are based on one or more user interactions with the one or more model variations.

14. A computer system for model evaluation and performance-based selection, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving a model and corresponding configuration information;
creating one or more model variations based on the model and the corresponding configuration information;
determining a model variation subset based on a threshold amount and one or more evaluation scores of each of the one or more model variations;
terminating processes and resources for the one or more model variations not included in the model variation subset;
initiating one or more new model variations based on the model variation subset;
determining a best model of the one or more new model variations based on one or more new model evaluation scores for each of the one or more new model variations; and
omitting the one or more new model variations except the best model.

15. The computer system of claim 14, the functions further comprising:
receiving interaction data for each of the one or more model variations; and
analyzing the one or more model variations to determine the one or more evaluation scores for each of the one or more model variations, wherein the one or more evaluation scores are based on the interaction data.

16. The computer system of claim 14, the functions further comprising:
assigning a protected classification to at least one of the one or more model variations, wherein the protected classification indicates that at least one of the one or more model variations is to be included in the model variation subset.

17. The computer system of claim 14, wherein the omitting further comprises:
omitting one or more processes corresponding to the one or more model variations not included in the model variation subset; and
omitting one or more resources corresponding to the one or more model variations not included in the model variation subset.

18. A non-transitory computer-readable medium containing instructions for model evaluation and performance-based selection, the instructions comprising:
receiving a model and corresponding configuration information;
creating one or more model variations based on the model and the corresponding configuration information;
determining a model variation subset based on a threshold amount and one or more evaluation scores of each of the one or more model variations;
terminating processes and resources for the one or more model variations not included in the model variation subset;
initiating one or more new model variations based on the model variation subset;
determining a best model of the one or more new model variations based on one or more new model evaluation scores for each of the one or more new model variations; and
omitting the one or more new model variations except the best model.

19. The non-transitory computer-readable medium of claim 18, wherein the one or more evaluation scores are based on one or more user interactions with the one or more model variations.

20. The non-transitory computer-readable medium of claim 18, wherein the configuration information includes one or more hyperparameters.
